(19) United States
(12) Patent Application Publication
(10) Pub. No.: US 2002/0094202 A1
(43) Pub. Date: Jul. 18, 2002

(54) Camera device with multiple lens units and having a function of changing focus automatically

(76) Inventor: Chien-Chuan Chen, Hsin-Sheng (TW)

Correspondence Address: Keith Kline, PRO-TECHTOR INTERNATIONAL SERVICES, 20775 Norada Court, Saratoga, CA, 95070-3018, US

(21) Appl. No.: 09/759,429

(22) Filed: Jan. 12, 2001

(51) Int. Cl. G03B 17/00

(52) U.S. Cl. 396/74

(57) ABSTRACT

A camera device with multiple lens units and having a function of changing focus automatically comprises: a camera unit with multiple lens units, an image display screen and an image control circuit. The camera unit includes a lens assembly with a plurality of lens units, a base tightly adhered to a back of the lens frame, an image sensor is installed on the base at a position with respect to the lens cavity; and at least one passive sensor being set with different sensing length which is exactly matched with the focus or visual angle of each lens set. The image control circuit is installed between the camera unit and the image display screen and has a detecting signal judging portion, a priority image operation portion, and an image display execution portion. The image display execution portion receives the signals from the detecting signal judging portion or priority image operation portion, and then receives images of a specific lens, and then actuates a screen and displaying the image on the screen. After displaying the image on the screen through a time period, then the operation is stopped. Thereby, the focusing and adjusting structure of a camera device is simplified. The lifetime is prolonged and the cost is reduced.

### FIELD OF THE INVENTION

The present invention relates to camera device with multiple lens units and having a function of changing focus automatically, wherein the camera device is formed by a plurality of lens arranged as a matrix and motion detector, such as infrared sensors or uttrasonic sensors. Thereby, images can be selected automatically economically so that the most necessary image can be displayed on a novel display screen.

### BACKGROUND OF THE INVENTION

Recently, since the technology about the image generating device (for example, camera device) has a great improvement so that the performance and the quality of the products are improved continuously. Especially, the cost is reduced vastly. For example, in the prior art, the precise lens must be made by precise grinding, but recently, the image sensor elements can be mass-produced by synthetic plastics through injection molding. Further, for the image sensor of a camera device, a CMOS (Complementary Metal Oxide Semiconductor) image sensor with lower power consumption and simple structure has been developed maturely and is used widely in various camera devices. The manufacturing process of the CMOS image sensor is a semiconductor process.

As that described hereinbefore, due to the progress of technology, costs of various key parts, such as lens, sensors, image processing elements, etc are reduced greatly so that the image processing devices can be widely used in various fields, such as home security, door monitoring, image phones, net meetings, low level cameras used in toys for being viewed by adults and children.

In many special fields in order to acquire a high performance, in general, an electromotive device for automatically adjusting the focus of lens, such as those described in FIGS. 4 and 5. In that, a servo motor A serves to drive a special designed gear driving device B for executing the zoom control and iris control for acquiring a better image. However, since the structure of the adjusting device is complex, volume of the motor and the gear driving device is too heavy, and the cost is high. It is easily worn for being used through a long time period. Therefore, the prior art electromotive device for automatically adjusting the focus of lens is necessary to be improved.

### SUMMARY OF THE INVENTION

Under the consideration of the defect of the electromotive focusing adjusting device in the prior art camera device and the cost reduction of the precise lens and CMOS image sensor. Therefore, these devices can be used widely, and thus, the present invention provides a camera device with multiple lens units and having a function of changing focus automatically, in which the focusing and adjusting structure of a camera device is simplified. The lifetime is prolonged and the cost is reduced. A camera unit with multiple lens units and an image display screen and an image control circuit. The camera unit includes a lens assembly with a plurality of lens units arranged as a matrix, a base, and at least one passive sensor. The image control circuit is installed between the camera unit and the image display screen and has a detecting signal judging portion, a priority image operation portion, and an image display execution portion.

The various objects and advantages of the present invention will be more readily understood from the following detailed description when read in conjunction with the appended drawing.

### BRIEF DESCRIPTION OF THE DRAWINGS

FIG. 1 is a perspective view of the camera device of the present invention.

FIG. 2 is a lateral cross sectional view of the present invention along line P-P of FIG. 1.

FIG. 3 is a functional block diagram of the image control circuit in the present invention.

FIG. 4 is a lateral view of a prior art camera device with an electromotive focusing adjusting lens.

FIG. 5 is front view of the prior art camera device in FIG. 4.

### DETAILED DESCRIPTION OF THE PREFERRED EMBODIMENTS

In the following, an embodiment about a passive monitoring camera device for house security is illustrated in the present invention. In this embodiment, the present invention has a camera unit 1 and an image display screen 2. An image control circuit 3 is installed between the camera unit 1 and the image display screen 2.

A front side of the camera unit 1 has a lens assembly 11 with a plurality of lens units. In this embodiment, four lens cavities 13 arranged as a rectangular shape is installed on a lens frame 12. Each lens cavity has a lens set 14. Each lens set 14 may be different focus or visual angle as required. For example, in this embodiment, assume that the first lens unit 11a has a visual angle of 5 degrees, the second lens unit 11b has a visual angle of 20 degrees, the third lens unit 11c has a visual angle of 57 degrees, and the fourth lens unit lid has a visual angle of 135 degrees. A base 15 is tightly adhered to the back of the lens frame 12. A CMOS image sensor 16 is installed on the base 16 at a position with respect to the lens cavity 13. The image signal captured by each lens unit 11 is transferred to the image control circuit for being processed.

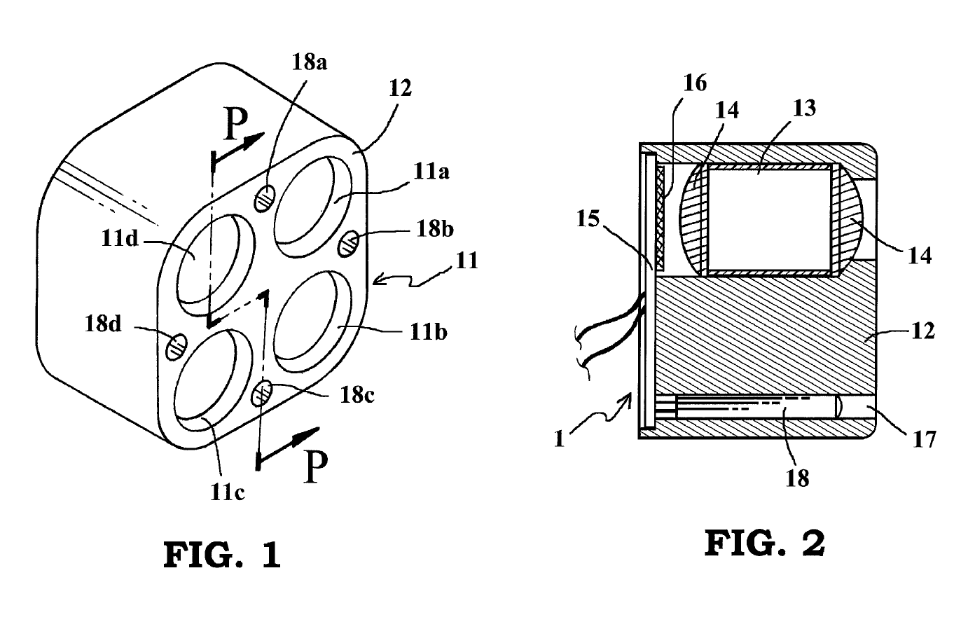

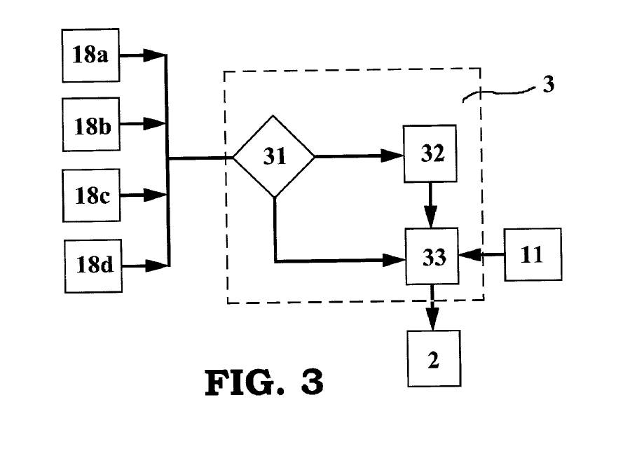

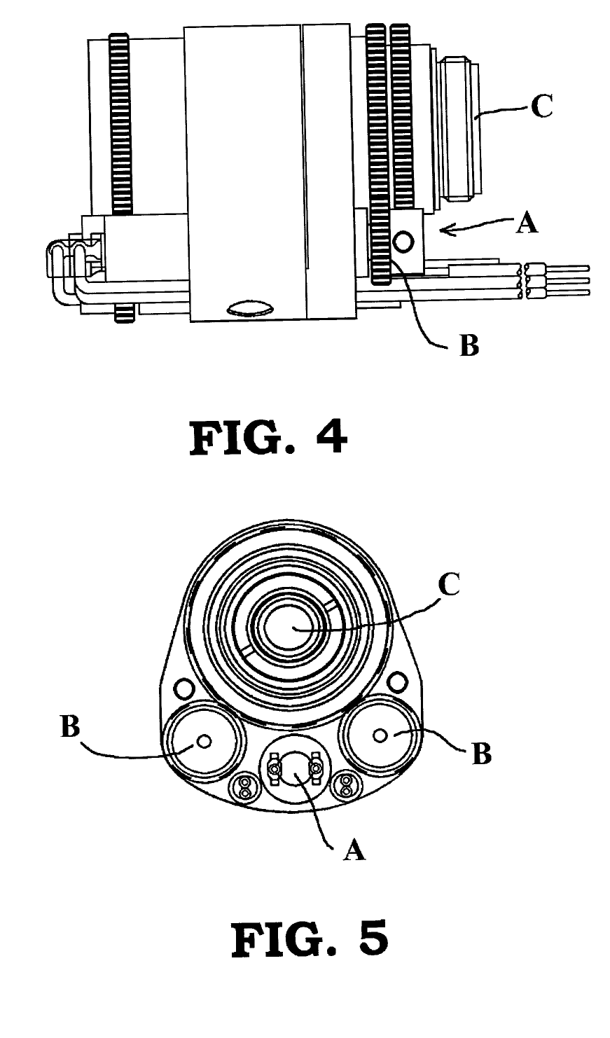

With reference to FIGS. 1 and 2, a sensing window 17 is installed proximately to each lens cavity 13. A passive infrared ray sensor (PIRs) 18 is installed in the sensing window 17. Each sensor 18 is set with different sensing length which is exactly matched with the focus or visual angle of each lens set 14. In this embodiment, the detecting distance of the first sensor 18a matching to the first lens unit 11a (having a visual angle of 5 degrees) is set at a value of about 20 m. The detecting distance of the second sensor 18b matching to the second lens unit 11b (having a visual angle of 20 degrees) is set at about 15 m. The detecting distance of the third sensor 18c matching to the third lens unit 11c (having a visual angle of 57 degrees) is set at about 10 m. The detecting distance of the fourth sensor 18d matching to the fourth lens unit 11d (having a visual angle of 135 degrees) is set at about 5 m.

Referring to FIG. 3, the image control circuit 3 is installed between the camera unit 1 and the image display screen 2. The insulating substrate 3 has a detecting signal judging portion 31, a priority image operation portion 32, and an image display execution portion 33. The detecting signal judging portion 31 receives the signals from the first to fourth sensor 18a, 18b, 18c, and 18d. When only one image sensor is triggered, the signal will be transferred to the image display execution portion 33 for being processed. When more than one image sensors are triggered, then signals are transferred to the priority image operation portion 32. The priority image operation portion 32 determines which of the receiving signals to be used as a priority signal and then transfers the priority signal to the image display execution portion 33. The selection of the priority signal is according to the use of the camera device. For example, in this embodiment, the camera device is used as a monitor for house security. Therefore, under the consideration of security, the monitoring frames is determined according to distance of the intruder, and thus, the priorities of the frames are the image of fourth lens unit 11d (visual angle 135 degrees, wide angle)→the image of third lens unit 11c→the image of second lens unit 11b→the image of first lens unit 11a (visual angle 5 degrees, far visual distance).

When the image display execution portion 33 receives the signal from the detecting signal judging portion 31 or priority image operation portion 32, the image display execution portion 33 executes the following operation at the same time. 1. Actuating a light source. 2. Receiving an image of a specific lens. 3. Actuating a screen and displaying the image on the screen. 4. After displaying the image on the screen through 30 seconds, then the operation is stopped.

In the aforesaid embodiment about the passive monitoring camera device for house security, when an intruder enters into the monitoring range, the passive sensors 18 will be triggered, and the sensed signals are processed by the detecting signal judging portion 31 and the priority image operation portion 32 of the insulating substrate 3. After the frame of the selected priority image is determined, the image display execution portion 33 actuates to display the image on the screen. This operation for automatically selecting the priority monitoring frame and displaying on the screen is continuous until the sensors 18 can not detect any one intruding the monitoring range.

Obviously, those skilled in the art may modify the embodiment within the scope of the present invention. For example, to acquire a more detail image, in this multiple lens structures with multiple lens units, the lens units can be arranged through 360 degrees for enlarging the monitoring range of the camera. The aforesaid passive infrared ray sensor can be replaced by a passive supersonic sensor. Furthermore, the image control circuit can be set as: when any sensor is triggered, the image display screen is actuated and then the images captured by all the lens units are displayed at the same time by dividing the frame into several sub-frames.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A camera device with multiple lens units and having a function of changing focus automatically comprising: a camera unit with multiple lens units and an image display screen and an image control circuit; wherein the camera unit includes:
a lens assembly with a plurality of lens units, a plurality of lens cavities arranged as a matrix being installed on a lens frame; each lens cavity having a lens set; and each lens set having different focus or visual angle as required;
a base tightly adhered to a back of the lens frame, an image sensor being installed on the base at a position with respect to the lens cavity; and
at least one passive sensor being set with different sensing length which is exactly matched with the focus or visual angle of each lens set; and
the image control circuit being installed between the camera unit and the image display screen, the image control circuit having a detecting signal judging portion, a priority image operation portion, and an image display execution portion;
the detecting signal judging portion receiving signals from the sensors; wherein when only one image sensor is triggered, the signal will be transferred to the image display execution portion for being processed; when more than one image sensors are triggered, then signals are transferred to the priority image operation portion;
the priority image operation portion for determining one of the receiving signals as a priority signal and then transferring the priority signal to the image display execution portion; and
the image display execution portion receiving the signals from the detecting signal judging portion or priority image operation portion, and then receiving images of a specific lens, and then actuating a screen and displaying the image on the screen; after displaying the image on the screen through a time period, then the operation is stopped.

2. The camera device with multiple lens units and having a function of changing focus automatically as claimed in claim 1, wherein the image sensor is a CMOS image sensor.

3. The camera device with multiple lens units and having a function of changing focus automatically as claimed in claim 1, wherein the passive sensor is an infrared sensor.

4. The camera device with multiple lens units and having a function of changing focus automatically as claimed in claim 1, wherein the passive sensor is a supersonic sensor.

5. The camera device with multiple lens units and having a function of changing focus automatically as claimed in claim 1, wherein all the lens units are arranged through 360 degrees

6. A camera device with multiple lens units and having a function of changing focus automatically comprising: a camera unit with multiple lens units and an image display screen and an image control circuit; wherein the camera unit includes:
a lens assembly with a plurality of lens units, a plurality of lens cavities arranged as a matrix being installed on a lens frame; each lens cavity having a lens set; and each lens set having different focus or visual angle as required;
a base tightly adhered to a back of the lens frame, a image sensor being installed on the base at a position with respect to the lens cavity; and
at least one passive sensor being set with different sensing length which is exactly matched with the focus or visual angle of each lens set; and
the image control circuit being installed between the camera unit and the image display screen; when any sensor is triggered, the image display screen is actuated and then the images captured by all the lens units being displayed at the same time by dividing the frame into several sub-frames.

7. The camera device with multiple lens units and having a function of changing focus automatically as claimed in claim 6, wherein the image sensor is a CMOS image sensor.

8. The camera device with multiple lens units and having a function of changing focus automatically as claimed in claim 6, wherein the passive sensor is an infrared sensor.

9. The camera device with multiple lens units and having a function of changing focus automatically as claimed in claim 6, wherein the passive sensor is a supersonic sensor.

10. The camera device with multiple lens units and having a function of changing focus automatically as claimed in claim 6, wherein all the lens units are arranged through 360 degrees
